(19) United States
(12) Patent Application Publication
(10) Pub. No.: US 2009/0166296 A1
(43) Pub. Date: Jul. 2, 2009

(54) WASTEWATER TREATMENT PLANT

(75) Inventors: Joseph Tigani, Tullamarine (AU); Terence G. Usher, Tullamarine (AU)

Correspondence Address: EDWARDS ANGELL PALMER & DODGE LLP, P.O. BOX 55874, BOSTON, MA, 02205, US

(73) Assignee: AQUENOX PTY LTD, Hawthorn (AU)

(21) Appl. No.: 11/720,864

(22) PCT Filed: Dec. 6, 2005
(86) PCT No.: PCT/AU2005/001843

§ 371 Date: May 19, 2008

(30) Foreign Application Priority Data
Dec. 6, 2004 (AU) 2004906961

(51) Int. Cl. C02F 1/52

(52) U.S. Cl. 210/716

(57) ABSTRACT

Apparatus for treatment of wastewater which has pre-treatment apparatus for treatment of wastewater which has at least two separation tanks connected in series through which the wastewater is passed wherein there is provided a vertically oriented baffle pipe having a closed top and an open bottom which is attached to or located adjacent a side wall of a first tank Which traps triglycerides, fats or other particulate impurities in the wastewater for subsequent passage into a second tank through a primary conduit which interconnects the first and second tanks. The apparatus also includes post-treatment apparatus for treatment of wastewater after passing through an electrocoagulation cell incorporating at least one coagulation tank having a baffle located below a top end of the coagulation tank which has a spray nozzle associated therewith for washing floc off an interior of the tank whereby the floc is discharged through a conduit which extends through a side wall of the tank below the baffle.

### FIELD OF THE INVENTION

This invention relates to a treatment plant for wastewater which utilises an electrocoagulation cell.

### BACKGROUND OF THE INVENTION

Hitherto conventional electrocoagulation treatment plants as described for example in WO 20041046045 and WO 03/086982 have utilised a pre-treatment assembly which may comprise one or more filters to remove solid contaminants from the wastewater, a mixing tank for the addition electrolytes to increase the conductivity of the wastewater and the use of flocculants or thickening agents to assist in efficient disposal of sludge. There also may be included an electrocoagulation cell and post treatment assembly which comprises one or more coagulation tanks to remove solid particles contained in the wastewater. Flocculants may also be added to accelerate gravity separation of such solid particles.

Reference also may be made to Japanese Patent Application 2004066037 which refers to a waste treatment plant especially for car washes which have pre-electrolytic treatment apparatus, an electrolytic cell and a post treatment apparatus comprising a reaction tank for addition of flocculant to the waste as it passes through the electrolysis tank and a subsequent separation tank. This reference also discloses recycling of the grey water from the carwash back to the pre-treatment apparatus after the purified water produced by the waste treatment plant has been utilised for cleaning of cars.

It will also be appreciated that conventional oil separators in one form comprise a tank having a plurality of weirs or baffles which makes wastewater flow in the tank adopt a serpentine shape. However maintenance of these conventional oil separators is time consuming and costly and in some cases is inefficient.

An additional problem with conventional wastewater treatment plants such as those described above have included the problem of addition of polymeric flocculants such as polyelectrolytes to post treatment apparatus after electrolysis or electrocoagulation which increases the problems of disposal of particulate waste and sludge. This is referred to especially in the Japanese reference referred to above.

### OBJECT OF THE INVENTION

It is therefore an object of the invention to provide a process for treatment of wastewater which reduces the problem of the prior art discussed above.

### SUMMARY OF THE INVENTION

In a first aspect of the invention provides pre-treatment apparatus for treatment of wastewater prior to electrocoagulation which comprises at least two separation tanks connected in series through which the wastewater is passed wherein there is provided a vertically oriented baffle pipe having a closed top and an open bottom which is attached to or located adjacent a side wall of a first tank which traps triglycerides, fats or other particulate impurities in the wastewater for subsequent passage into a second tank through a primary conduit which interconnects the first and second tanks. The second tank may also incorporate a similar baffle and there also may be a third separation tank which is in flow communication with the second tank by a secondary conduit.

The pre-treatment apparatus may also include a waste pipe located adjacent an external surface of the first sedimentation tank and preferably above the top of the baffle pipe. The waste pipe may have an aperture extending through a side wall of the first tank and into the waste pipe for removal of scum, oils and the like.

In a second aspect of the invention there may be provided a post treatment apparatus for treatment of wastewater after electrocoagulation incorporating at least one coagulation tank having a baffle located below a top end of the coagulation tank which has a spray nozzle associated therewith for washing floc off an interior of the tank whereby the floc is discharged through a conduit which extends through a side wall of the tank below the baffle.

In one embodiment the spray nozzle may be located in a top wall of the tank above the baffle for washing off floc located on a top surface of the baffle. In this embodiment the baffle may be located adjacent an inlet conduit for wastewater so that floc may have access to the top surface of the baffle.

However in a more preferred arrangement the nozzle may extend through the baffle for washing internal wall(s) of the tank whereby the floc is discharged through a discharge conduit located below the baffle.

In a third aspect of the invention there is provided a storage assembly of wastewater for a wastewater plant which includes a first storage tank and a second storage tank with flow conduits extending between the first storage tank and the second storage tank whereby the second storage tank may function as an overflow or provide additional storage space for the first storage tank in the case when the first storage tank is full to capacity.

In this aspect of the invention the first storage tank may comprise an underground pit or sump and the second storage tank may comprise a tank located upstream of the underground pit or sump. The sump may also be provided with a high level switch and a low level switch for determining when flow of wastewater between the sump and upstream tank may occur.

It will also be appreciated that the invention includes within its scope both the pre-treatment apparatus and the post treatment apparatus.

### BRIEF DESCRIPTION OF THE DRAWINGS

The invention is exemplified in the preferred embodiments shown in the attached drawings wherein:

FIG. 1 is a schematic flow sheet of a treatment plant for, wastewater including a electrocoagulation cell showing a pre-treatment assembly of settling tanks for wastewater flowing from a sump to the electrocoagulation cell followed by a post treatment assembly of coagulation tanks before discharge of the purified wastewater;

FIG. 2 is a detailed view of the pre-treatment assembly shown in FIG. 1;

FIG. 3 is a detailed view of the post treatment assembly shown in FIG. 1 but modified to exclude the pre-treatment assembly shown in FIG 1;

FIG. 4 is a view showing a sump and holding pit storage assembly for use in the treatment plant shown in FIG. 1.

### DETAILED DESCRIPTION OF THE PREFERRED EMBODIMENTS

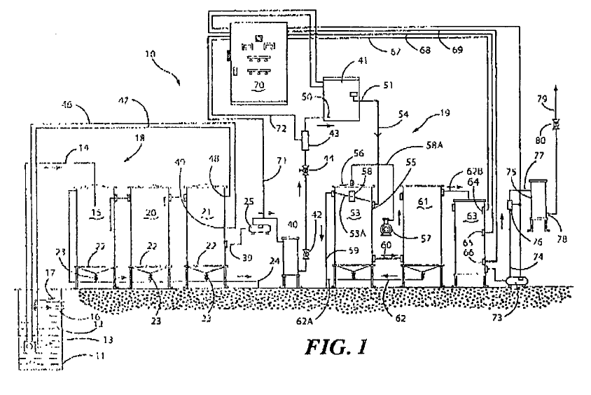

In the treatment plant shown in FIG. 1 there is provided a complete wastewater treatment plant 10 having a sump or underground holding pit 11 for wastewater effluent 12 which has a submersible pump 13, conduit 14 for passage of effluent to settling tank 15, overflow port 16 and return port 17 for recycled purified waste which is returned to sump 11 from a carwash (not shown) where the purified wastewater after being applied in washing a vehicle (not shown) is returned through a return conduit (not shown) which communicates with return port 17.

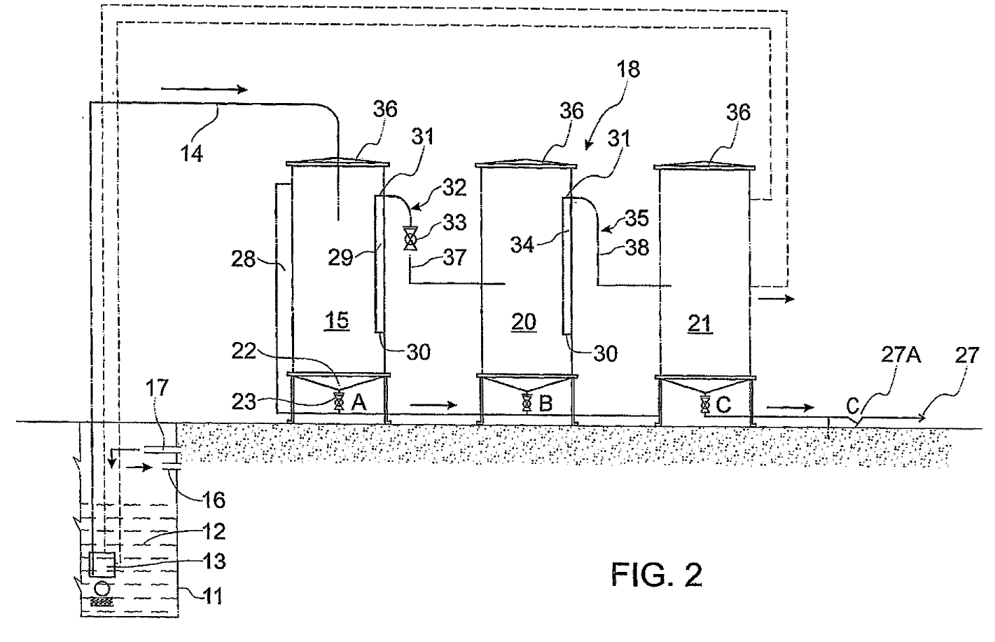

FIG. 2 shows a detailed view of the pre-treatment assembly 18 shown in FIG. 1 which comprises settling tank 15, settling tank 20 and settling tank 21 all connected in series for the flow of wastewater. Settling tank 15 has a conical drainage base 22 which is provided with a ball valve 23 which is a ball valve. Sediment waste is discharged from the base 22 through valve 23 into sediment waste conduit 24. This process is continued in settling tank 20 and settling tank 21 where sediment is also discharged into conduit 24 through base 22 and valve 23. Sediment is finally discharged at 27 after passage through in line strainer 27A which is rated at 1000μ to 2000μ.

Settling tank 15 is provided with waste pipe 28 as well as baffle pipe 29 having an open bottom 30 and closed top 31. The provision of waste pipe 28 is useful in that it facilitates separation of finely divided waste or scum along with oils or other light waste from the wastewater and this material is transferred into sediment conduit 24 from waste pipe 28. There is provided an outlet aperture (not shown) between the interior of tank 53 to pipe 28. Also as effluent rises in tank 15 the solids such as triglycerides ort fats as well as grease and other solid impurities in the effluent are retained within the baffle pipe 29 and thus pass out of tank 15 into tank 20 through transfer conduit 32 between tank 15 and tank 20. The provision of baffle pipe 29 ensures that unwanted solids are deposited onto base 22 of tank 20.

After passage through tank 15 and transfer conduit 32 and after passing through ball valve 33 the effluent is passed into settling tank 20 also provided with baffle pipe 34 for facilitating sediment solids from tank 20 passing through transfer conduit 35 into tank 21. Each of tanks 15, 20 and 21 are provided with closed tops or lids 36 and each of transfer conduits 32 and 35 transfer wastewater partly under the influence of gravity as shown in vertical parts 37 and 38. Baffle pipe 34 carries out the same function as baffle pipe 29.

Finally wastewater passes onto settling tank 21 which does not have a baffle pipe and wastewater may pass through transfer conduit 39 into prefilter tank 40 best shown in FIG. 1 by the agency of pump 25. Wastewater may then pass from prefilter tank 40 into electrocoagulation cell 41 after passage through delivery conduit 45 having check valve 42, flow sensor 43 and flow control valve 44.

Electrical connections 46 and 47 are shown between submersible pump 13 and high level switch 48 and midlevel switch 49 so as to control flow of wastewater through tanks 15, 20 and 21. Thus pump 13 is only active when wastewater is located between switches 48 and 49.

EC cell 41 has wastewater entering through inlet port 50 and exits through outlet port 51. Wastewater may then be passed from outlet port 51 to coagulation tank 53 through vertical conduit 54. Wastewater may then enter coagulation tank 53 through inlet port 55. There is also provided pump 57 for pumping water through conduit 58A to the top 56 of coagulation tank for spraying water through spray nozzle 58. Also shown in coagulation tank 53 is inclined baffle 53A which facilitates transfer of flocculent through an outlet aperture (not shown) into waste conduit 59 after the top surface of baffle 53A is sprayed with water from nozzle 58. There is also provided a horizontal transfer conduit 60 between coagulation tank 53 and coagulation tank 61 and coagulant waste may be discharged into coagulant discharge conduit 62B from drainage bases 22 and associated check valves 23 of each coagulation tank 53 and 61 for disposal. In this regard conduits 59 and 62 are joined at 62A.

In another embodiment the spray nozzle 58 may also extend through baffle 53A in phantom instead of top 56. In this embodiment the space above baffle 53 is not used and nozzle 58 cleans the underside of baffle 53A as well as internal wall(s) of tank 53 to facilitate floe passing into conduit 59.

Finally wastewater may be transferred by transfer conduit 62B into holding tank 63 having midlevel switch 65 and high level switch 64. There is also provided low level switch 66. Each of switches 64, 65 and 66 are provided with electrical connections 67, 68 and 69 to control panel 70. Control panel 70 also has electrical connections 71 and 72 to pump 25 and flow sensor 43.

Finally wastewater is passed from holding tank 63 via discharge pump 73 into vertical conduit 74 to post filter tank 75 via upper inlet 77 after passage through pressure switch 76. Wastewater may then pass from post filter tank 75 from bottom outlet port 78 to conduit 79 to a treatment such as a carwash (not shown).

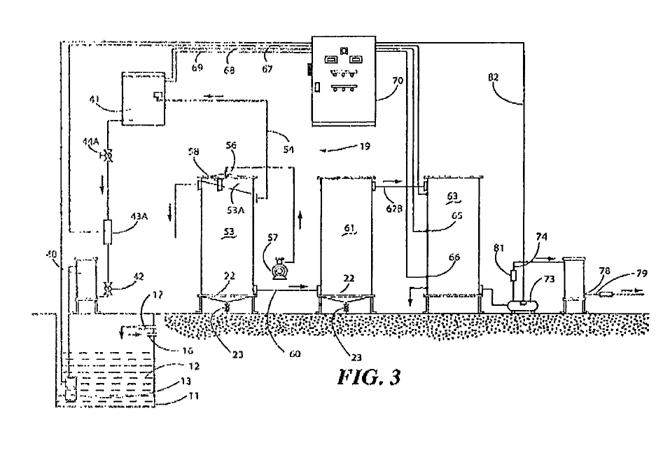

FIG. 3 shows basically the same post treatment assembly 19 shown in FIG. 1 with the important modification that the pretreatment assembly 18 shown in FIG. 1 has been omitted and thus sump or holding pit 11 is directly connected to prefilter tank 40 and EC cell 41. Also shown is flow control valve 44A and flow sensor 43A. Also shown is pressure switch 81 and electrical connection 82 to control panel 70. Otherwise the same reference numerals are used as shown in FIG. 1 and thus the flow of wastewater is as already described in FIG. 1.

However it is useful to note in FIG. 3 that low flow from the delivery pump 13 will shut down the delivery pump 13 and EC cell 41. The low level switch 66 will stop discharge pump 73 and the midlevel switch 64 will start discharge pump 73. The high level switch 65 will stop the EC cell 41 and delivery pump 13. When the level of liquid in the holding tank 63 drops from the high level switch 65 to the midlevel switch 64 the EC cell 41 and the delivery pump 13 will start automatically.

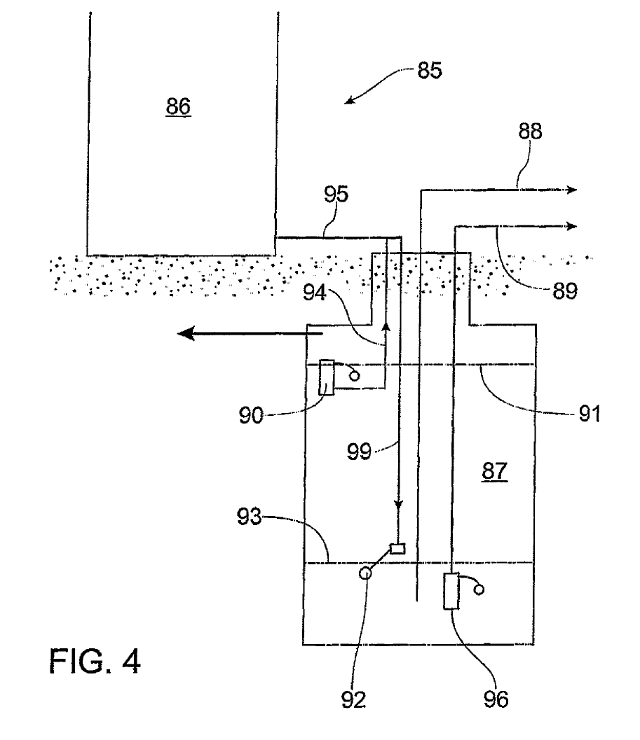

In FIG. 4 there is shown a storage assembly 85 for wastewater which includes an upstream holding tank 86 and a sump or underground pit 87. There is also provided a return conduit 88 for grey water which has been generated by washing a vehicle at a carwash (not shown). There is also provided a forward or feed conduit 89 for transporting effluent stored in sump 87 for processing through a treatment plant shown in FIG. 1 or FIG. 3. The sump 87 is provided with a high level pump switch 90 which is activated when wastewater in sump 87 reaches level 91 and a low level switch 92 which is activated when the level of wastewater in sump 87 is at level 93. Thus if grey water recycled to sump 87 rises above level 91 then this excess grey water is pumped to upstream holding tank 86 through conduit 94 and conduit 95.

However, if the level of grey water in sump 87 falls below level 91 the pump is then stopped from transferring wastewater to holding tank 86. When the height of water reaches level 93 then the switch 92 is activated to transfer water from holding tank 86 back to sump 87 through conduits 99 and 95.

The purpose of the storage assembly 85 is to protect the automatic delivery pump 96 from running out of wastewater for pumping purposes. Thus pump 96 is always below the level of wastewater in sump 87. Pump 96 is associated with conduit 89 as shown.

If both the holding tank 86 and sump 87 are filled to capacity then wastewater is discharged into the sewer through conduit 98.

The storage assembly 86 shown in FIG. 4 ensures sufficient collection and control of excess effluent where particular wastewater installations have holding capacity above their sump or pit capacity. The storage assembly 85 therefore provides for balance or an equilibrium between the pit and the holding tank in regard to capacity of wastewater.

1-13. (canceled)

14. A process for treatment of wastewater which includes the steps of:
(i) passing wastewater through an electrocoagulation tank whereby coagulant is generated in an electrocoagulation cell and passed out through an outlet of the electrocoagulation cell and into at least one coagulation tank.
(ii) removing coagulant from the wastewater by contacting a baffle located below a top end of the said at least one coagulation tank with the wastewater.
(iii) discharging the coagulant from the at least one coagulation tank through a conduit which extends through a side wall of the at least one coagulation tank below the baffle; and
(iv) passing a remaining wastewater with the coagulant substantially removed therefrom from said at least one coagulant tank separately from the coagulant.

15. A process as claimed in claim 14 wherein in step (iv) the wastewater is transferred into a second coagulation tank connected to said at least one coagulation tank in series.

16. A process as claimed in claim 1 wherein the wastewater, prior to electrocoagulation in step (i), is passed through at least two separation tanks connected in series wherein in a first separation tank wastewater passes through a vertically oriented pipe having an open bottom wherein said pipe collects triglycerides, fats or other particulate impurities in the wastewater for subsequent passage of the wastewater from said first separation tank to a second of said separation tanks.

17. A process as claimed in claim 16 wherein the second separation tank is also provided with said vertically oriented pipe for removal of said particulate impurities from the wastewater.

18. A process as claimed in claim 16 or claim 17 wherein there is provided a third separation tank in flow communication with the second separation tank into which said wastewater with said particulate impurities substantially removed therefrom is transferred before step (i).

19. A process as claimed in claim 18 which includes a waste pipe located adjacent an external surface of the separation tank which extends through a side wall of the first separation tank for removal of scum, oils and the like.

20. A process as claimed in claim 19 wherein the waste pipe extends above the vertically oriented pipe.

21. A process as claimed in claim 20 wherein the baffle has an inclined upper surface extending downwardly from an upstream side of the said at least one coagulation tank to a downstream side of the said at least one coagulation tank.

22. A process as claimed in claim 21 wherein there is further provided spray nozzle located above a top surface of the baffle for cleaning said top.

23. A process as claimed in claim 21 wherein the spray nozzle extends through the baffle for washing internal wall(s) of the said at least one coagulation tank and coagulant is discharged through a discharge conduit located adjacent and extending downwardly from a downstream end of the baffle.

24. A process as claimed in claimed in claim 21 wherein the baffle is located adjacent an inlet conduit for wastewater so that the coagulant is in flow communication with the upper surface of the baffle.
